(19) United States
(12) Patent Application Publication
(10) Pub. No.: US 2018/0050361 A1
(43) Pub. Date: Feb. 22, 2018

(54) SPRAY GUN HAVING A TRIGGER LOCK, TRIGGER LOCK FOR A SPRAY GUN, AND METHOD FOR ATTACHING, FOR ACTIVATING, AND FOR DEACTIVATING A TRIGGER LOCK

(71) Applicant: SATA GmbH & Co. KG, Kornwestheim (DE)

(72) Inventor: Ralf GEHRUNG, Backnang (DE)

(73) Assignee: SATA GmbH & Co. KG, Kornwestheim (DE)

(21) Appl. No.: 15/679,533

(22) Filed: Aug. 17, 2017

(30) Foreign Application Priority Data
Aug. 19, 2016 (DE) 102016009957.7

(51) Int. Cl. B05B 12/00

(52) U.S. Cl. CPC B05B 12/002; B05B 7/1218

(57) ABSTRACT

A spray gun, in particular a paint spray gun, having a trigger lock with at least one slider element. The slider element, both in the activation position as well as in the blocking position, is at least partially located in an intermediate space between the trigger lever and the gun body. Also disclosed are a trigger lock for a spray gun, a method for attaching a trigger lock to a spray gun, a method for activating a trigger lock of a spray gun, and a method for deactivating a trigger lock of a spray gun.

### FIELD OF THE DISCLOSURE

The disclosure relates to a spray gun, in particular a paint spray gun, to a trigger lock for a spray gun, to a method for attaching a trigger lock to a spray gun, to a method for activating a trigger lock of a spray gun, and to a method for deactivating a trigger lock of a spray gun.

### BACKGROUND

Spray guns, in particular paint spray guns, are used for spraying paint as well as for spraying adhesives and lacquers, in particular base and clear lacquers, both solvent-based and water-based, and likewise for spraying etchants and stains, other timber protection agents, and liquids for the foodstuffs industry, or for spraying other liquids. In particular, spray guns can be classified as hand-held spray guns and automatic or robotic guns, respectively. Hand-held spray guns are used above all by tradesmen, in particular painters, joiners, and varnishers. Automatic or robotic guns are typically used in conjunction with a painting robot or a painting machine for industrial applications. However, it is quite conceivable for a hand-held spray gun to be integrated in a painting robot or in a painting machine.

Spray guns, in particular paint spray guns, can be designed as a gravity-cup gun having a paint cup that is disposed above the gun body and from where the material to be sprayed flows into and through the paint ducts substantially by gravity. The spray gun can however also be a side-cup gun in which the paint cup is disposed laterally on the gun body, and in which the material is likewise infed to the gun by gravity. However, the spray gun can also be designed as a suction-cup gun, having a paint cup that is disposed below the gun body, from which the material to be sprayed is suctioned from the cup substantially by negative pressure, in particular by utilizing the vacuum effect generated at the paint nozzle by the air exiting the air nozzle. Furthermore, said spray gun can also be designed as a pressure-cup gun, in which the cup is disposed below, above, or laterally on the gun body and is impinged with pressure, whereupon the medium to be sprayed is forced out of the cup. Furthermore, said spray gun can be a bucket gun in which the medium to be sprayed is infed to the spray gun from a paint container by means of a hose.

Spray guns, in particular paint spray guns, can furthermore be differentiated in terms of how and at what pressure the atomization of the material to be sprayed is performed. In the case of air-atomizing paint spray guns, the material to be atomized that is forced or suctioned out of a paint nozzle is atomized by an air stream which is in most instances atomized from an annular gap which is disposed about the paint nozzle. Depending on the spraying pressure, air-atomizing paint spray guns can be subdivided inter alia into conventional spray guns, HVLP (high volume low pressure) spray guns, and LVLP (low volume low pressure) spray guns. By contrast, airless guns operate without air. The atomization herein is performed in that the material to be sprayed is forced at high pressure though a nozzle having a very small internal diameter. In the case of air-assisted airless guns, the material to be sprayed is likewise forced through a nozzle having a very small internal diameter, wherein the pressure here is somewhat lower than in the case of airless guns. The spray jet is subsequently impinged with compressed air in order for the former to be further atomized, softened and optionally shaped. In the case of electrostatic guns, the material to be sprayed is electrically charged, on account of which the released spray droplets in an ideal case migrate to the workpiece that is earthed. In the case of electrostatic guns, the atomization can be performed with as well as without air.

The above-mentioned spray guns can have dissimilar components and be of dissimilar construction. For example, an air-assisted airless gun of the type mentioned at the outset according to the prior art on the head thereof has a preliminary nozzle which is screw-fitted into the gun body, an annular air distributor which is plug-fitted into the gun body often being disposed therebehind. The preliminary nozzle often has a front portion of which the front end often has a planar face having a small circular opening, wherein the opening can be surrounded by a hollow-conical stud. The external side wall of the front portion can be designed as a regular hexagon such that the preliminary nozzle can be unscrewed from the gun body and screw-fitted thereinto again by means of an open or ring spanner or of a special tool for spray guns, in particular a universal spanner or a similar tool.

A planar portion which has a larger external diameter than the front portion and which surrounds the front portion and in which a plurality of air bores, preferably six air bores, which run through the entire thickness of the portion are incorporated is disposed behind the front portion. The bores are preferably inclined in the direction of the longitudinal axis of the nozzle. A hollow-cylindrical connection portion having an external thread by means of which the preliminary nozzle can be screw-fitted into the gun head which has an internal thread that communicates with the external thread mentioned is disposed behind that portion of the preliminary nozzle that has the air bores.

The small circular opening in the interior of the preliminary nozzle is often surrounded by a sealing element. The front end of a paint needle bears on this sealing element in the case of a non-activated trigger lever. This front end of the paint needle has a radius and in particular is designed so as to be semi-spherical and in the case of a non-activated trigger lever closes the opening of the preliminary nozzle such that no spray medium exits the preliminary nozzle.

The spray gun furthermore has an air cap having a central opening. A material nozzle is capable of being inserted into this air cap in such a manner that a front part of the material nozzle protrudes from the central opening of the air cap. The material nozzle is preferably mounted in the air cap so as be secured against rotation, or is mounted on the inside of the air cap by means of a stud that engages in a groove on the outside of the material nozzle.

The material nozzle has a material bore of which the internal diameter is even smaller than the circular opening in the preliminary nozzle, the internal port of said material bore being surrounded by a sealing element and the external material outlet opening of said port typically being configured as a small bore which is incorporated in the center of a V-shaped slot. The diameter of the bore and the opening angle of the V-shaped slot can vary so as to depend on the desired material throughput and the desired jet width.

The air cap having the material nozzle lying therein can be plug-fitted to the preliminary nozzle by means of a frictionally engaged connection which is established by a rubber or plastic ring that is disposed on the preliminary nozzle or on the air cap in a connection region between the preliminary nozzle and the air cap. The hollow-conical stud of the preliminary nozzle in this assembled state bears on the sealing element of the internal port of the material nozzle such that the material to be sprayed, which exits the preliminary nozzle under high pressure, can transfer without any losses to the material nozzle from which the material to be sprayed can then likewise exit under high pressure and be atomized. The material exiting the nozzle is atomized because said material is forced through a very small nozzle under high pressure, on account of which the material attains a very high velocity. Once said material when exiting the nozzle impacts the stationary ambient air, forces which rip apart the jet into threads and droplets act on the spray jet.

The air cap furthermore often has two horns which are diametrically opposed and in the outflow direction project beyond the central opening of the air cap. Two supply bores, that is to say horn air supply ducts, lead from the rear side of the air cap to horn air ducts in the horns. Each horn typically has at least one horn air duct. Each horn air duct on the outside thereof has at least one horn air opening from which the horn air exits. The horn air ducts or openings, respectively, are typically oriented such that they point toward a point that is close to the exit point of the paint jet from the material nozzle, such that the so-called horn air that exits the horn air openings can influence the paint jet that exits the material nozzle. The paint jet is homogenized and post-atomized on account thereof.

So-called round jet openings can be incorporated in the front face of the air cap so as to be radially outside the central opening. By virtue of the shape of the material outlet opening of the material nozzle, the paint jet has an elongate elliptical cross section. If a jet having a circular cross section is desired, for example because an area that is smaller than the length of the wide jet is to be painted, the round jet openings can be opened to air by means of a round-wide jet regulating installation on the spray gun. The air that flows out of the round jet openings in this instance impacts the wide jet and compresses the latter. The round jet air is capable of being regulated in a stepless manner such that the jet shape is also capable of being regulated in a stepless manner. The above-mentioned anti-rotation device of the material nozzle in the air cap ensures that the material nozzle at all times assumes the correct position relative to the round jet openings.

The head of the gun body typically has an external thread by way of which an annular air nozzle having the air cap with the material nozzle disposed therein is screw-fitted to the gun head.

The spray gun can furthermore have a reversible nozzle that is known from the prior art, having a reversing switch which is likewise known. Backwashing of the nozzle in the case of any congestion of the nozzle is possible by means of this system.

A spray gun as has been described above as well as one of another type can furthermore have in particular the following components: a grip, an upper gun body, a compressed-air connector, a trigger lever for opening an air valve and for moving the paint needle out of the internal port of the preliminary nozzle, a round-wide jet regulating feature for regulating the quantity of added air in order for the paint jet to be formed, an air micrometer for setting the spray pressure, a material connector, paint ducts for directing the material to be sprayed from a material inlet to the material outlet, compressed-air ducts, a suspension hook, and an analog or digital pressure-measuring installation. Said spray gun can however also have further components from the prior art.

In the case of bucket guns, airless guns and air-assisted airless guns the material to be sprayed is supplied to the spray gun from a paint container by means of a hose, typically with the aid of a pump. The spray gun on the lower side thereof has a material connector. The material connector can comprise a paint tube which can be equipped with a material filter installed therein.

By virtue of the high pressure of often many hundred bars at which the spray medium exits the material nozzle in particular in the case of airless and air-assisted airless guns, there is an increased risk of injury when the spray gun is unintentionally activated. For this reason, airless and air-assisted airless guns of the type mentioned at the outset above all have a nozzle guard which is a type of spacer which is placed onto the gun head. The nozzle guard is often designed as a ring having a plurality of, typically four, projecting arms, wherein in each case two arms at the front ends thereof are interconnected by way of stays. As a further installation for increasing the operational safety, spray guns which are operated at high pressure have a trigger lock which prevents any unintentional activation of the spray gun or of the trigger lever, respectively.

Trigger locks of this type in the prior art are often designed as a rotary lever which is disposed on the side of the gun body and which can be rotated in the direction of the trigger lever so as to block the trigger lever. A detent in the form of a pin is often disposed on the side of the gun body in order for the position of the trigger lever to be fixed.

Foldable trigger locks which are disposed on the front side of the gun grip so as to be behind the trigger lever, for example, or on the rear side of the trigger lever, and which for blocking the trigger lever can be folded to the front or to the rear, respectively, are furthermore known.

It is disadvantageous in the case of these solutions that the trigger locks are in the range of movement of the user of the spray gun, that is to say in a region with which the user comes into contact or may come into contact in the use of said spray gun. On account thereof there is the risk of the trigger lock being unintentionally released and the trigger lever no longer being protected against any unintentional activation. Furthermore, the above-mentioned trigger locks disturb the visual appearance of the spray gun, and in particular in the case of trigger locks that are capable of folding there is the risk of parts of the folding mechanism breaking off. The attachment of the trigger lock in the case of the solutions according to the prior art is performed in the production of the spray gun. Further processing steps, for example the incorporation of at least one bore, are required in order for the spray gun to be rendered suitable for being equipped with a trigger lock. The trigger lock subsequently has to be attached, for example screw-fitted, to the spray gun. The often very small and not ideally accessible trigger lock has to be rotated, pivoted, or folded for activation or deactivation.

EP 0 313 958 B1 proposes a spray or spray mist gun having a trigger lock, wherein the trigger lock is disposed in the grip of the gun and for activation is displaceable into the path of the lower end of the trigger lever. It is disadvantageous in this solution that the production effort is relatively high.

### SUMMARY

It is therefore the object of the present invention to provide a spray gun having a trigger lock and a trigger lock for spray gun, in which the risk of any unintentional release, that is to say deactivation, of the trigger lock is lower than in the case of trigger locks according to the prior art, which are integrated in the design of the spray gun in a less conspicuous manner, and which are producible in a simple manner. It is furthermore the object of the present invention to provide a method for attaching such a trigger lock to a spray gun. A further object of the present invention is to provide a method for activating and a method for deactivating a trigger lock of a spray gun by way of which method the activation or the deactivation, respectively, of the trigger lock is simpler than in the prior art, in particular in which the activation travel, that is to say the path that has to be traveled by the trigger lock or at least one part of the latter in order for the trigger lock to be activated, or the space which the trigger lock or at least one part of the latter requires for this purpose, can be kept smaller than in the case of solutions according to the prior art.

The first object is achieved by a spray gun, in particular a paint spray gun, which has at least a gun body, a trigger lever and a trigger lock for preventing actuation of the trigger lever, wherein at least one part of the trigger lock is displaceable from an activation position, in which the activation of the trigger lever is possible, to a blocking position, in which the activation of the trigger lever is not possible, and is displaceable from the blocking position to the activation position, wherein the trigger lock has at least one slider element, and the slider element both in the activation position as well as in the blocking position is at least partially disposed in an intermediate space between the trigger lever and the gun body.

The first object is further achieved by a trigger lock for a spray gun, wherein said trigger lock has at least a slider element and a fastening means for disposing the trigger lock at least partially in an intermediate space between a trigger lever of a spray gun and a gun body of a spray gun.

The second object is achieved by a method for attaching a trigger lock to a spray gun, in particular a paint spray gun, wherein at least one part of the trigger lock is displaceable from an activation position, in which the activation of the trigger lever is possible, to a blocking position, in which the activation of the trigger lever is not possible, and is displaceable from the blocking position to the activation position, and wherein the trigger lock has at least one slider element, and the attachment is performed in such a manner that the slider element both in the activation position as well as in the blocking position is at least partially disposed in an intermediate space between the trigger lever and the gun body.

The third object is achieved by a method for activating and by a method for deactivating a trigger lock of a spray gun, in particular a paint spray gun, wherein the activation and the deactivation, respectively, comprise at least one sliding motion, and wherein a slider element both prior to as well as after the activation and the deactivation, respectively, of the trigger lock is at least partially located in an intermediate space between the trigger lever and the gun body. The term “activation” in this context is understood to mean moving the trigger lock to the blocking position. The term “deactivation” in this context is understood to mean moving the trigger lock to the activation position.

The term “slide” is presently understood to mean moving a component by exerting pressure or traction on said component, wherein the movement is performed along an axis which can be straight or curved. Sliding per se does not comprise any rotating, pivoting, or folding movement; however, the sliding motion can be followed by a rotating, pivoting, or folding movement, for example in order for the trigger lock to be fixed. Accordingly, a slider element is understood to be an element or an assembly of a plurality of elements of which at least part is designed so as to be capable of sliding. In particular, various parts of the slider element can be mutually displaceable.

The slider element both in the activation position as well as in the blocking position being at least partially located in an intermediate space between the trigger lever and the gun body is presently understood to mean that the mentioned part of the of the slider element is disposed in the intermediate space between the trigger lever and the gun body, said intermediate space becoming smaller in the case of an activation of the trigger lever. This here is often the intermediate space between the trigger lever and that part of the gun body that lies to the rear of the trigger lever, wherein that side or that direction, respectively, that is opposite to the spray direction of the spray gun is to be understood as the “rear”. The trigger lock and the slider element, respectively, do not need to be disposed completely in the mentioned intermediate space between the trigger lever and the gun body. Rather, the trigger lock and the slider element can also project from or beyond this intermediate space.

Advantageous design embodiments are the subject matter of the dependent claims.

On account of the activation of the trigger lock in the case of the spray gun according to the invention, or of the trigger lock according to the invention, being performed by means of a slider element, the activation travel, that is to say the path that has to be traveled by the trigger lock or at least one part of the latter in order for the trigger lock to be activated, or the space which the trigger lock or at least part thereof requires for this purpose, can be kept smaller as is the case with a foldable trigger lock. Furthermore, the trigger lock both in the activated as well as the non-activated state can lie close to the gun body such that the risk of any unintentional release is minimized. Furthermore, the trigger lock can or will be attached to the spray gun in an inconspicuous manner, and said trigger lock can be better integrated in the design of the spray gun. The risk of damage to the trigger lock can also be reduced. The at least partial arrangement of the slider element in an intermediate space between the trigger lever and the gun body has the advantage that this part of the slider element during the handling of the spray gun does not lie in the usual motion range of the user, on account of which the risk of any unintentional release of or damage to the trigger lock is reduced. The production of the spray gun or of the trigger lock, respectively, is relatively simple.

The method for attaching the trigger lock offers commensurate advantages.

As opposed to the prior art, the method according to the invention for activating the trigger lock of a spray gun, and the method according to the invention for deactivating the trigger lock of a spray gun, have the advantage that the sliding motion which is required for activating and deactivating, respectively can be carried out in a very simple manner. On account of the slider element both prior to and after activation of the trigger lock being at least partially located in an intermediate space between the trigger lever and the gun body, the user can activate the trigger lock by using the thumb of the same hand by which he/she holds the spray gun.

A spray gun of which the trigger lock is designed in such a manner that the slider element in the activation position is at least partially disposed in a first region of the intermediate space between the trigger lever and the gun body, and that the slider element in the blocking position is at least partially disposed in a second region of the intermediate space between the trigger lever and the gun body, and that at least one dimension of the slider element corresponds approximately to the spacing between the non-activated trigger lever and the gun body in the second region of the intermediate space between the trigger lever of the spray gun and the gun body of the spray gun is particularly preferred. That part of the trigger lock or of the slider element, respectively, that is displaceable into the mentioned second region of the intermediate space in order to activate the blocking position must be dimensioned in such manner that the trigger lever cannot be moved up to that point at which the paint needle is pulled or forced back, respectively, in order for the spray medium to be released. The mentioned part of the trigger lock or of the slider element, respectively, in all cases described above is preferably dimensioned in such a manner that the trigger lever cannot be moved at all or can hardly be moved. That is to say that the mentioned part of the trigger lock or of the slider element, respectively, in the case of a non-activated trigger lever completely or almost completely fills the second region of the intermediate space between the trigger lever and the gun body.

The slider element of the trigger lock preferably has at least a gliding rail and a gliding element. The gliding rail herein is preferably fixedly disposed on a part of the spray gun, the gliding element running on and along said gliding rail. For example, the gliding rail can have lateral grooves into which webs on the gliding element engage. Alternatively or additionally, the gliding element can have lateral grooves into which webs on the gliding rail engage. A gliding rail having lateral parts in the form of a “T” or of a “U” on its side is also conceivable, the gliding element engaging in said lateral parts. A further possibility for a design embodiment of the slider element is for the gliding rail and the gliding element to be connected by means of a dovetail connection or guide, respectively. However, other design embodiments by way of which the gliding element is disposed so as to be displaceable on the gliding rail are also conceivable. The displacement herein can be performed along a rectilinear line; however, the gliding element and the gliding rail can also be designed in such a manner that the gliding element is displaceable along a curve. The gliding rail herein can be designed so as to be curved. The gliding element in this instance is advantageously designed so as to be also curved or straight, but in the latter case so as to be so short that said gliding element can nevertheless follow the curved track and does not jam therein. The slider element can also be designed as a tube having an internal gliding element, for example. Design embodiments of this type will also be considered a gliding rail and a gliding element hereunder.

Alternatively, however, the slider element can also be designed so as to be integral. In particular, said slider element can be composed of only a gliding element, wherein the gliding element utilizes the trigger lever of the spray gun or part of the latter as a gliding rail and slides on or in the latter, that is to say is disposed or disposable, respectively, so as to be displaceable on, at or in the trigger lever. In this case, the trigger lever in portions can be designed like the gliding rail that has been described above. For the sake of simplicity, that component on which the gliding element glides is referred to as the gliding rail; however, it has to be highlighted that this can also be understood to refer to the trigger lever.

The slider element can have a fixing mechanism by means of which the position of the gliding element on, in or at the gliding rail is capable of being fixed. The fixing mechanism can be designed as a latching mechanism, for example. The gliding element can have latching cams which latch into grooves in the gliding rail when the gliding element has reached a specific position. Alternatively or additionally, the gliding element can have grooves, and the gliding rail can have latching cams. The slider element is preferably held in the blocking position, that is to say in that position in which the activation of the trigger lever is not possible, by means of the fixing mechanism. Alternatively or additionally, the slider element can however also be held in the activation position, that is in that position in which the activation of the trigger lever is possible, by means of the fixing mechanism. The fixing mechanism can be designed in such a manner that said fixing mechanism can be released again by way of a comparatively small force acting on the gliding element in the gliding direction. In this case, the fixing mechanism fixes the position of the gliding element on the gliding rail in relation to gravity and to other small forces acting thereon, but can however also be released by activating the gliding element such that the gliding element can be displaced with a minor effort in terms of force, even when the slider element is located in the latching position. In this case, the force which in the activation of the trigger lever of the spray gun acts on the slider element must not act in the direction of the direction of movement of the slider element or of the gliding element, respectively, since the trigger lock would otherwise be released by the activation of the trigger lever. Rather, the trigger lock in this case has to be designed or disposed such that the force which acts on the slider element in the case of the activation of the trigger lever of the spray gun ideally acts perpendicularly to the direction of movement of the slider element or of the gliding element, respectively. However, the force which in the activation of the trigger lever of the spray gun acts on the slider element can also act in that direction in which the slider element or the gliding element, respectively, has to be slid in order for the blocking position of the trigger lock to be activated. On account thereof, the trigger lock in the activation of the trigger lever is held in the blocking position.

However, the fixing mechanism can also be designed in such a manner that said fixing mechanism cannot be readily released again by a relatively small force acting on the gliding element. Said fixing mechanism can be designed in such a manner that an additional movement or the activation of an additional element is required in order for the fixing mechanism to be released. For example, the fixing mechanism can be designed in such a manner that the gliding element must be slightly raised, that said gliding element has to be slightly pressed onto the gliding rail, or that said gliding element has to be slightly compressed in order for the fixing mechanism to be released. However, the activation of a rotary button, of a lever, or the like, can also be required for releasing. Depending on how well the gliding element is fixed to the gliding rail and on how robustly the slider element is designed, the slider element can even be designed in such a manner that the fixing element withstands the force which in the activation of the trigger lever of the spray gun acts on the slider element. In this case, the force which in the activation of the trigger lever of the spray gun acts on the slider element can also act in the direction of the direction of movement of the slider element or of the gliding element, respectively. However, it is nevertheless more reliable when the force which in the activation of the trigger lever of the spray gun acts on the slider element ideally acts perpendicularly to the direction of movement of the slider element or of the gliding element, respectively, or acts in the direction in which the slider element or the gliding element, respectively, has to be slid in order for the blocking position of the trigger lock to be activated.

The gliding rail preferably has grooves, and the gliding element preferably has webs, wherein the webs of the gliding element engage in the grooves of the gliding rail. The grooves are preferably non-continuous but rather terminate ahead of the end of the gliding rail. On account thereof, a detent can be created and the gliding element can be held in the gliding rail. The grooves can also commence only beyond the start of the gliding rail such that a detent can also be created on the opposite side, such that the gliding element cannot inadvertently be slid off the gliding rail. The arms or webs, respectively, of the gliding element can be designed so as to be slightly flexible in order for the former to be able to snap into the groove. The arms, or an edge of the arms, respectively, can have a chamfer or a rounded feature on at least one side in order to facilitate sliding the gliding element onto the gliding rail. Alternatively or additionally, an edge of the gliding rail can also be beveled or rounded.

Alternatively or additionally, however, grooves and webs or arms can also be disposed in the reverse manner, that is to say that the gliding element has grooves in which webs on the gliding rail engage. The subject matter described above can apply here in an analogous manner.

The slider element at least in portions preferably has a taper. Particularly preferably, the gliding rail of the slider element at least in portions has the taper. In particular, the gliding rail can become narrower in at least one direction, or become wider in at least one other direction, while the gliding element across the entire length thereof has the same width. In particular, the spacing between the arms or the webs, respectively, of the gliding element which engage in the lateral grooves of the gliding rail can be constant across the entire length of the gliding element. On account thereof, the actuation of the slider element as from a specific point onward can be rendered so as to be more sluggish, even in a successive or creeping manner. On account thereof, a certain fixation of the gliding element on the gliding rail can also be achieved alternatively or additionally to that of the fixing mechanism. Alternatively or additionally, the gliding rail across the entire length thereof can have the same width, the spacing of the arms or webs, respectively, of the gliding element becoming smaller, or the arms or the webs, respectively, on the inside thereof becoming thicker, however.

Alternatively to the design embodiment described above, the gliding element and the gliding rail can be interconnected by means of a dovetail guide.

The slider element can be disposed on the gun body of the spray gun; however, the slider element is preferably disposed on the trigger lever of the spray gun, particularly preferably on the inside of the trigger lever, that is to say the rear side thereof, that is to say that side that faces away from the gun head. Trigger levers of spray guns typically have a U-shaped cross section, having one front face and two lateral faces. The slider element is particularly preferably disposed on the inside, that is to say on that side of the front face of the trigger lever that faces away from the gun head. At least one part of the slider element can be disposed so as to be non-releasable on the trigger lever of the spray gun. However, at least one part of the slider element can also be disposed so as to be releasable on the trigger lever of the spray gun. It can be provided that at least one part of the slider element is disposed on the trigger lever of the spray gun so as to be releasable only by means of a tool. On account of such or another non-releasable attachment of the trigger lock or part thereof, or of an attachment that is releasable only by means of a tool, it can be ensured that the trigger lock is not inadvertently released from the spray gun unnoticed.

The spray gun according to the invention can also have two or more trigger locks, wherein one trigger lock can be disposed on the gun body and one trigger lock can be disposed on the trigger lever. The second trigger lock can serve as a standby in case of a defect with the first trigger lock, for example.

If the spray gun is an air-atomizing gun or an air-assisted airless gun, the spray gun preferably has an air piston rod which is movable by activating the trigger lever and opens or closes, respectively, an air valve. In the case of some spray guns, the air piston rod protrudes from the gun body behind the trigger lever and in the activation of the trigger lever is moved into the gun body, on account of which an air piston head that is located at the rear end of the air piston rod is moved out of the seat of said air piston head so as to release an opening through which the compressed air can flow. The flow cross section for the compressed air and thus the quantity of air can be additionally set by way of an air micrometer. The slider element of the trigger lock can be designed in such a manner that the slider element is at least partially displaceable into an intermediate space between the trigger lever and that region of the gun body of the spray gun that surrounds the air piston rod. Since the spacing between the non-activated trigger lever and the gun body in this region is relatively small, the slider element of the trigger lock can be dimensioned so as to be relatively small in order for the locking effect to be achieved. A region within a radius of 10 mm about the air piston rod is considered that region of the gun body of the spray gun that surrounds the air piston rod.

In the case of some spray guns, it is not or not only the air piston rod that protrudes from the gun body, but also at least one part of the paint needle or of an element, for example a rod, that is coupled to the paint needle. The paint needle is also movable by activating the trigger lever. In the activation of the trigger lever the paint needle is moved rearward out of the paint nozzle and exposes the outlet of the paint nozzle to the material to be sprayed. The slider element is preferably designed in such a manner that the slider element is at least partially displaceable into an intermediate space between the trigger lever and that region of the gun body of the spray gun that surrounds the paint needle, or into an intermediate space between the trigger lever and that region of the gun body of the spray gun that surrounds the element that is coupled to the paint needle. It applies here too that the spacing between the non-activated trigger lever and the gun body in this region is relatively small such that the slider element of the trigger lock can be dimensioned so as to be relatively small in order for the locking effect to be achieved. It applies here too that a region within a radius of 10 mm about the paint needle is considered that region of the gun body of the spray gun that surrounds the paint needle. The same applies in an analogous manner to that region of the gun body of the spray gun that surrounds the element that is coupled to the paint needle.

The spray gun can have a component, for example an air valve shaft or a sealing element, that protrudes slightly from the gun body and seals an air piston rod or a paint needle that protrudes from the gun body in relation to the gun body. In the case of a fully pulled trigger lever, a region of the trigger lever, in particular a region of the inside of the front face of the trigger lever, can bear on one of these components. In the case of one exemplary embodiment of a spray gun according to the invention, or of a trigger lock according to the invention, respectively, the trigger lock is disposed and designed in such a manner that the trigger lock or the slider element, respectively, is at least partially displaceable into the intermediate space between the trigger lever and the component which protrudes slightly from the gun body and on which the inside of the front face of the trigger lever bears in the case of a fully pulled trigger lever. On account thereof, the trigger lever can no longer be moved up to the gun body or to that component that protrudes from the gun body, respectively. Here too, a region within a radius of 10 mm about the component that protrudes from the gun body is considered that region of the gun body of the spray gun that surrounds the component that protrudes slightly from the gun body.

Genuine airless guns operate without compressed air and therefore have no air piston rod. However, since the trigger lever in the case of airless guns also moves along a segment of a circular path about a fastening point and dissimilar points of the trigger lever in the activation of the trigger lever thus travel dissimilar distances, the spacing between the non-activated trigger lever and the gun body here too in at least one region of the intermediate space between the trigger lever and the gun body is smaller than in at least one other region of the intermediate space. The slider element is to be at least partially displaceable to this region of the intermediate space that has a relatively small spacing, in order for the slider element of the trigger lock to be able to be dimensioned relatively small for the locking effect to be achieved. In general, the slider element is preferably designed in such a manner that the slider element is at least partially displaceable from a first region of the intermediate space between the trigger lever and the gun body, having a comparatively large spacing between the trigger lever and the gun body, to a second region of the intermediate space, having a comparatively small spacing between the trigger lever and the gun body. Likewise, the slider element in general is preferably at least partially displaceable from a region of the intermediate space between the trigger lever and the gun body, having a comparatively large spacing from the center of rotation of the trigger lever, to a region of the intermediate space between the trigger lever and the gun body, having a comparatively small spacing from the center of rotation of the trigger lever. Since there is often a smaller spacing between the trigger lever and the gun body in such a region that is close to the center of rotation or to the articulation than in a region that is spaced farther apart from the center of rotation of the trigger lever, the slider element of the trigger lock can thus also be dimensioned so as to be relatively small in order for the locking effect to be achieved. That point or that axis, respectively, about which the trigger lever that is attached to the gun body in the activation of the former moves is understood herein to be the center of rotation of the trigger lever.

Spray guns typically have a grip by which the spray gun is held during the operation. The gun grip is typically disposed at an angle of approx. 100° to 110° to the upper gun body, on account of which an ergonomic operation is possible. The grip is often composed of a wide lower and a narrow upper grip region, wherein the two regions are mutually separated by a plateau. The plateau projects beyond the wide lower grip region. In one preferred exemplary embodiment of the spray gun according to the invention, the slider element is designed in such a manner that the slider element for activating the blocking position of the trigger lock is at least partially displaceable to a region below the trigger lever and in front of the grip. In particular, the slider element is at least partially displaceable to in front of the plateau of the grip. The trigger lever can also be blocked in the triggering direction on account thereof.

The spray gun can furthermore have a shoulder or an add-on part on the gun body, wherein the slider element can be designed in such a manner that the slider element is at least partially displaceable to a region in front of the shoulder, or in front of the add-on part, respectively. For example, the slider element in the activation position of the trigger lock can be located so as to be at least partially oblique in front of and below a round-wide jet regulating button on the side of the gun body. In order for the trigger lock to be moved to the blocking position, the slider element is at least partially moved upward directly in front of the round-wide jet regulating button. Since the slider element in the activating direction of the trigger level and in the direction counter thereto is immovably connected to the trigger lever, that part of the slider element that is located in front of the round-wide jet regulating button obstructs the activation of the trigger lever. Of course, that part of the slider element that bears on the round-wide jet regulating button in the activation position can also be located above the round-wide jet regulating button and can be configured as a type of hook, wherein the slider element is slid downward in order for the trigger lock to be moved to the blocking position, such that the hook encompasses the round-wide jet regulating button. The add-on part can also be a material quantity regulating screw, an air micrometer, a compressed air connector, a material supply installation, or another add-on part. The add-on part does not have to have a function that is independent of that of the trigger lock. Rather, said add-on part herein can also be an element which complements the trigger lock; for example, said add-on part can be a filler piece which reduces the intermediate space between the trigger lever and the gun body that is to be filled by the trigger lock, or by at least one part of the slider element, respectively, in order for the blocking position to be activated.

A spray gun in which the trigger lever on the inside thereof has a damper installation is preferred, wherein the damper installation is disposed in front of a component which is moved by the trigger lever. Said damper element can be a plastic plate which is disposed on the inside of the front face of the trigger lever and which is fastened to the trigger lever by means of one, preferably at least two, pins. The component which is moved by the trigger lever can be an air piston rod, a paint needle, or an element that is coupled to the paint needle, for example. This plate in the activation of the trigger lever pushes against the air piston rod, for example, on account of which an activation of the air piston rod that is more silent and more gentle is possible as would be the case if the metallic trigger lever were to push against the likewise metallic air piston rod.

Such a plastic plate can also be employed when the trigger lever does not move an air piston rod but only a paint needle or an element that is coupled to the paint needle. This is the case in particular with airless guns.

Of course, the plate can also be composed of a material other than plastic, for example of rubber.

The trigger lever of the spray gun particularly preferably has a receptacle installation for receiving the damper installation, wherein the receptacle installation is designed in such a manner that the latter is suitable for receiving at least one part of the trigger lock. The part of the trigger lock is particularly preferably the gliding rail or a fastening means on the gliding rail, respectively. The damper installation has a fastening means by means of which the former is disposed or can be disposed on the trigger lever in that said fastening means is or can be connected to the receptacle installation of the trigger lever. At least one part of the trigger lock, in particular the gliding rail, likewise has a fastening means, wherein this fastening means corresponds at least partially to the fastening means of the damper installation, that is to say that at least parts of the two fastening means are of identical or similar design. On account thereof, the receptacle installation of the trigger lever is suitable either for receiving the damper installation or else for receiving the at least one part of the trigger lock. In order to be equipped with a trigger lock, the trigger lever thus does not have to be modified since the receptacle installation for receiving the fastening means of the trigger lock is already present. The trigger lock can be disposed on the trigger lever instead of the damper installation. On account thereof, a spray gun can also be retro-fitted with the trigger lock in that the damper installation is replaced by the trigger lock. As has been described above, the damper installation as well as the part of the trigger lock as a fastening means can have one or preferably at least two pins which can be plug-fitted into one or at least two holes, respectively, in particular bores, in the trigger lever. The pins can be designed so as to be hook-shaped such that the damper installation or the part of the trigger lock can be clipped onto the trigger lever. However, the pins can also be designed in such a manner that said pins upon being plugged into the holes in the trigger lever project on the other side of the holes and the diameter of the pins in the projecting regions is enlarged in such a manner by forming the projecting regions, for example by melting or hammering, that said projecting regions no longer pass though the holes in the trigger lever and the damper installation, or the part of the slider element, respectively, can no longer be removed from the trigger lever, or be removed only by means of a tool. A non-reversible attachment, or an attachment that is not reversible in a non-destructive manner, respectively, for example welding or adhesive bonding, of the damper installation and/or of the part of the slider element is also conceivable. Pins and holes can be disposed on top of one another as well as beside one another or so as to be mutually oblique. Of course, the trigger lever can also have the pins, and the part of the trigger lock, or the damper installation, respectively, can have the holes. It likewise goes without saying that other fastening means can also be employed.

The slider element preferably has an activation region, that is to say a region which is designed for being gripped by the user in order for the slider element to be activated, that is to say in order for the trigger lock to be moved from an activation position to a blocking position, or from a blocking position to an activation position. The activation region can be designed as an elevation, in particular as a cam, web, or winglet, for example. However, the activation region can also be configured as a depression. Alternatively or additionally to each design embodiment, the activation region can have a corrugation. The activation region is intended for facilitating the user in the activation of the slider element or of part thereof, respectively, in that said activation region renders the slider element or part thereof, respectively, more readily accessible and/or improves gripping said slider element or part thereof, respectively.

The trigger lock is particularly preferably at least partially composed of plastic, of a plastic compound, or of a plastic composition. On account thereof, said trigger lock can be produced in a simpler and more cost-effective manner than a slider element of metal. Furthermore, a trigger lock of plastic has a lower weight than a trigger lock of metal. However, the trigger lock at least in regions can also be composed of another material, in particular of metal.

The trigger lock can at least partially be made by means of a generative or additive production method, respectively. A multiplicity of different methods, in particular 3-D printing, are known in the prior art here.

In one preferred exemplary embodiment, the spray gun according to the invention has a suspension installation that is disposed so as to be releasable on the gun body. This herein can be a hook or an eyelet, for example, which, for example, can be screw-fittable to the gun body and removable therefrom and be mutually interchangeable. On account thereof, the spray gun according to the invention can be adapted for the attachment to various suspension devices such as, for example, bars, eyelets, etc. The hook and the eyelet can be disposed in such a manner that the spray gun is mounted perpendicularly to the suspension device; however, said hook and eyelet can also be disposed in such a manner that the spray gun is mounted so as to be in line with or oblique to the suspension device. Of course, the spray gun can have both a hook and an eyelet, or else any other suspension installation.

The spray gun according to the invention preferably has a material supply installation. Airless and air-assisted airless guns which, as has been described above, most often have or need to have a trigger lock, often have a so-called paint tube which is attached to the lower side of the gun. A material tube which leads to a paint container, in particular a pressurized container, to a tank or to a bucket, is disposed or disposable on that end of the paint tube that faces away from the gun. The material to be sprayed is supplied to the spray gun by way of a pump. However, the material supply installation can also be designed as a gravity cup, a suspended cup, or a side cup, or as a material tube without a paint tube. The paint tube, the cup, and the hose, can have a filter which filters solid matter and lumps of paint from the paint.

Apart from the components mentioned above, the spray gun according to the invention can have other components that are known from the prior art, in particular those described above, for example at least a paint needle, an annular air distributor, a preliminary nozzle, a material nozzle, a trigger lever guard, an air cap, or a reversible nozzle. The circumstances that have been illustrated above in the context of the description of the prior art can also be present in the case of the present spray gun according to the invention, in particular the arrangement of the preliminary nozzle, the annular air distributor, the paint needle, the air cap, the material nozzle, the annular air nozzle, the trigger lever, etc.

The present spray gun according to the invention can in particular be a high-pressure spray gun, an airless gun, or an air-assisted airless gun. However, said spray gun according to the invention can also be an air-atomizing spray gun, in particular a conventional spray gun, an HVLP (high volume low pressure) spray gun, or an LVLP (low volume low pressure) spray gun.

The trigger lock according to the invention for a spray gun, in particular a paint spray gun, which is characterized in that said trigger lock has at least a slider element and a fastening means for disposing the trigger lock at least partially in an intermediate space between the trigger lever and the gun body is preferably attachable in a releasable manner to a spray gun, in particular a paint spray gun. Said trigger lock, or part thereof, respectively, is particularly preferably releasable from the spray gun, in particular from the trigger lever of the spray gun, only by means of a tool, for example of a screw driver or of a special tool, or releasing is significantly facilitated by the use of the tool, respectively.

Particularly preferably, the trigger lock is attached or is capable of being attached to a spray gun, in particular a paint spray gun, in such a manner that the slider element in the activation position is at least partially located in a first region of the intermediate space between the trigger lever of the spray gun and the gun body of the spray gun, and the slider element in the blocking position is at least partially located in a second region of the intermediate space between the trigger lever of the spray gun and the gun body of the spray gun, and that at least one dimension of the slider element corresponds approximately to the spacing between the non-activated trigger lever and the gun body in the second region of the intermediate space between the trigger lever and the gun body.

In the case of one preferred exemplary embodiment, at least one part of the slider element is capable of being disposed so as to be displaceable on, at, or in the trigger lever. The slider element can be designed so as to be integral, in particular, said slider element can be composed of only a gliding element, wherein the gliding element utilizes the trigger lever of the spray gun as a gliding rail and slides on, at, or in the latter, that is to say is disposed or disposable, respectively, so as to be displaceable on or in the trigger lever. In this case, the trigger lever in portions can be designed like the gliding rail that has been described above.

The statements made above in the context of the description of the spray gun according to the invention apply in an analogous manner to the trigger lock according to the invention.

In the case of the method according to the invention for attaching a trigger lock to a spray gun, in particular a paint spray gun, in which method at least one part of the trigger lock is displaceable from an activation position, in which the activation of the trigger lever is possible, to a blocking position, in which the activation of the trigger lever is not possible, and is displaceable from the blocking position to the activation position, and which method is characterized in that the trigger lock has at least one slider element and in that the attachment is performed in such a manner that the slider element both in the activation position as well as in the blocking position is at least partially disposed in an intermediate space between the trigger lever and the gun body, the slider element is preferably disposed on the trigger lever of the spray gun, in particular on the inside of the trigger lever of the spray gun.

At least one part of the slider element is preferably disposed so as to be non-releasable, or so as to be releasable only by means of a tool, on the trigger lever of the spray gun.

The trigger lock is preferably attached to or incorporated in a receptacle installation in or on the trigger lever.

The receptacle installation is preferably suitable for receiving a damper installation.

The damper installation is preferably removed from the receptacle installation prior to the trigger lock being attached to or incorporated in the receptacle installation.

The explanations made above apply in an analogous manner to the method according to the invention for the attachment of a trigger lock to a spray gun, in particular a paint spray gun.

In the case of the method according to the invention for activating a trigger lock of a spray gun, in particular a paint spray gun, which method is characterized in that the activation comprises at least one sliding motion, and in that a slider element both prior to as well as after the activation of the trigger lock is at least partially located in an intermediate space between the trigger lever and the gun body, the slider element is preferably at least partially slid from a first region of the intermediate space, having a comparatively large spacing between the trigger lever and the gun body, to a second region of the intermediate space, having a comparatively small spacing between the trigger lever and the gun body.

In the case of the method according to the invention for deactivating a trigger lock of a spray gun, in particular a paint spray gun, which method is characterized in that the deactivation comprises at least one sliding motion, and in that a slider element both prior to as well as after the deactivation of the trigger lock is at least partially located in an intermediate space between the trigger lever and the gun body, the slider element is preferably at least partially slid from a second region of the intermediate space, having a comparatively small spacing between the trigger lever and the gun body, to a first region of the intermediate space, having a comparatively large spacing between the trigger lever and the gun body.

In the case of the method according to the invention for activating and in the method according to the invention for deactivating a trigger lock of a spray gun, in particular a paint spray gun, the explanations made above apply in an analogous manner.

### BRIEF DESCRIPTION OF THE DRAWINGS

The invention will be explained in more detail hereunder in an exemplary manner by means of five drawings in which

FIG. 1 shows a perspective view of an exemplary embodiment of a spray gun according to the invention, having an exemplary embodiment of a trigger lock according to the invention in the activation position;

FIG. 2 shows a perspective view of the exemplary embodiment of a spray gun according to the invention from FIG. 1, having the exemplary embodiment of a trigger lock according to the invention from FIG. 1 in the blocking position;

FIG. 3 shows an exploded drawing of a trigger lever of a spray gun according to the invention, having the exemplary embodiment of a trigger lock according to the invention from FIG. 1;

FIG. 4 shows a sectional illustration of a trigger lever of a spray gun according to the invention, having the exemplary embodiment of a trigger lock according to the invention from FIG. 1; and

FIG. 5 shows a side view of the exemplary embodiment of a spray gun according to the invention from FIG. 1, having the exemplary embodiment of a trigger lock according to the invention from FIG. 1.

### DETAILED DESCRIPTION

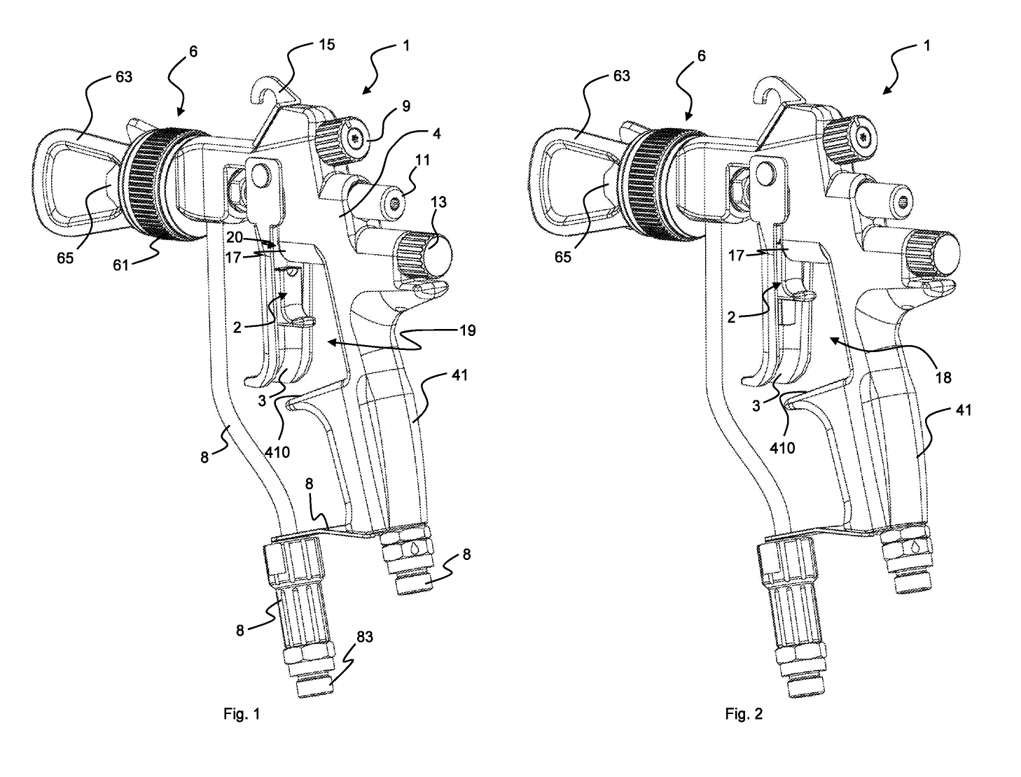

The exemplary embodiment of a spray gun according to the invention shown in FIG. 1 is a so-called air-assisted airless gun. This type of spray gun has already been explained in detail above.

The spray gun 1 has an exemplary embodiment of a trigger lock 2 according to the invention, said trigger lock 2 presently being disposed on the trigger lever 3 of the spray gun 1, in particular on the inside of said trigger lever 3, that is to say on the rear side thereof, or that side that faces away from the gun head, respectively. In the case of the present trigger lever 3 having a U-shaped cross section with one front face and two lateral faces, the trigger lock is disposed on the inside, that is to say on that side of the front face of the trigger lever 3 that faces away from the gun head 6. The trigger lock 2 is presently composed of a slider element 21 and a fastening means (not visible in FIG. 1). The gun head 6 has inter alia an annular air nozzle 61, a nozzle guard 63, and an air cap 65. Parts such as an annular air distributor, a preliminary nozzle, and a material nozzle, that are located in the interior of the gun head 6 are not shown in FIG. 1 but may be present. An air connector 43 for connecting a compressed air hose (not illustrated in FIG. 1) is disposed on the lower end of the gun body 4 of the spray gun 1, in particular on the lower end of the grip 41. The supply of the material to be sprayed, in particular of the paint to be sprayed, in the present exemplary embodiment is performed in particular by way of a paint tube 8 which is disposed on the lower side of an upper part of the gun body 4. The paint tube 8 is connected to a paint duct (not visible in FIG. 1) in the interior of the gun body 4 such that the material to be sprayed can be squeezed from the paint tube 8 out of the paint nozzle (not visible in FIG. 1) and be atomized. The paint tube 8 has a filter holder 81 and a filter (not shown in FIG. 1) that is disposed therein, and a hose connector 83. A material hose which leads to a paint container, in particular to a canister, a tank, a pressurized container, or a bucket, from which the material to be sprayed is conveyed by way of a pump to the spray gun 1 can be connected to the hose connector 83.

The spray gun 1 shown in FIG. 1 furthermore has a round-wide jet regulating feature 9 of which only the adjustment screw can be seen in FIG. 1. The shape of the spray jet can be set by activating the round-wide jet regulating feature. Should the paint nozzle have an opening having a slot-shaped cross section, the wide jet that exits the nozzle can be deformed to a round jet by adding horn air. Should the paint nozzle have an opening having a circular cross section, the round jet that exits the nozzle can be deformed to a wide jet by adding horn air. In both cases, controlling the quantity of horn air and thus setting the jet shape is preferably performed in a stepless manner.

The spray gun 1 furthermore has a cap screw 11 which is disposed level with and behind a paint needle (not visible in FIG. 1) which in regions runs within the gun body 4, said cap screw holding the paint needle in the gun body 4. A compression spring of which the rear end bears on the inner end face of the cap screw 11 and of which the front end bears on a stopper that is fixedly connected to the paint needle is disposed in the sleeve-shaped cap screw 11. The rear part of the paint needle herein runs within the compression spring. In the case of a non-activated trigger lever, the paint needle by way of the compression spring is pushed against the interior of the paint nozzle opening and is held there, on account of which the passage of material is blocked.

The spray gun 1 furthermore has an air micrometer of which only the adjustment button can be seen in FIG. 1. The air micrometer serves for regulating the quantity of air which can flow from the air duct in the gun grip 41 into the air ducts in the upper part of the gun body 4.

A spacer 5 which is disposed on the lower end of the gun grip 41 in front of the air connector 43 and encompasses the paint tube 8 guarantees reliable fixing of the paint tube 8.

In FIG. 1 and FIG. 2, the exemplary embodiment of a trigger lock 2 according to the invention is shown in the activation position (FIG. 1) and in the blocking position (FIG. 2), respectively. The intermediate space 18 between the trigger lever 3 and the gun body 4 can be seen in FIG. 2. This intermediate space 18 is the intermediate space between the trigger lever 3 and the gun body 4 that is decreased in size in the activation of the trigger lever. The first region 19 and the second region 20 of the intermediate space 18 can be seen in FIG. 1. That region of the intermediate space 18 from the upper face of the plateau 410 of the grip 41 up to the lower edge of the step 17 of the gun body 4 is defined as the first region 19 in the present exemplary embodiment. That region of the intermediate space above the lower edge of the step 17 of the gun body 4 is to be seen as the second region 20 in the present exemplary embodiment. In the position of the trigger lock 2 shown in FIG. 1, the activation of the trigger lever 3 is possible, that is to say that the trigger lock is located in the activation position. The trigger lock 2, or the slider element 21, respectively, is located in the first region 19 of the intermediate space 18 between the trigger lever 3 and the gun body 4, said first region 19 in the present exemplary embodiment being located below the second region 20 of the intermediate space 18, wherein the second region 20 represents that region having the comparatively small spacing between the trigger lever 3 and the gun body 4 in the activating direction of the trigger lever 3.

By contrast, the trigger lock 2 in FIG. 2 is located in the blocking position, that is to say that the activation of the trigger lever 3 is not possible. The trigger lock 2 in the blocking position is at least partially located in the second region 20 of the intermediate space 18 between the trigger lever 3 and the gun body 4, that is to say that the trigger lock 2 has been partially displaced from the first region 19 of the intermediate space 18, having the comparatively large spacing between the trigger lever 3 and the gun body 4, to the second region 20 of the intermediate space 18, having the comparatively small spacing between the trigger lever 3 and the gun body 4. The thickness of that part of the trigger lock 2 that is located in the second region 20 is preferably only slightly smaller than the spacing between the trigger lever and the gun body in the second region 20 of the intermediate space 18 between the trigger lever 3 and the gun body 4. The thickness of that part of the trigger lock 2 that is located in the second region 20 of the intermediate space 18 is dimensioned at least in such a manner that the trigger lever cannot be moved up to that point at which the paint needle is moved out of the paint nozzle opening.

In the activation position shown in FIG. 1, all parts of the trigger lock 2 can lie outside the second region 20 of the intermediate space 18, but at least a thin part of the trigger lock 2, for example a fastening means, can also be located within the second region 20, however. This part should not restrict the desired activation travel of the trigger lever 3, however.

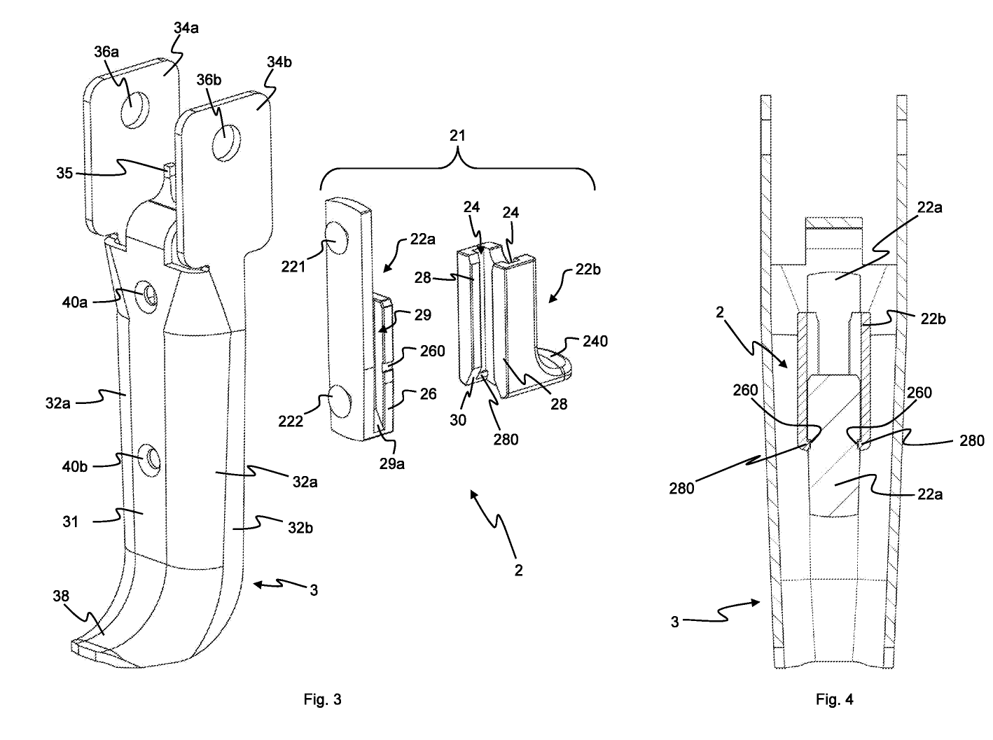

FIG. 3 shows an exploded view of the trigger lever 3 and of the trigger lock 2 from FIGS. 1 and 2. In the present exemplary embodiment, the trigger lever has an upper region having two arms 34a, 34b, wherein bores 36a, 36b for rotatably mounting the trigger lever 3 on the spray gun body 4, for example by means of a bolt, are incorporated in the arms 34a, 34b. The trigger lever 3 furthermore has a lower region having one front face 31 and two lateral faces wherein the lateral faces, like in the present exemplary embodiment, in turn each can be composed of one oblique face 32a and one straight face 32b that is disposed so as to be substantially perpendicular to the front face 31. The trigger lever 3 is preferably made from one piece in that the contour of the trigger lever 3 is fine-blanked or punched from a metal sheet and is bent or pressed into shape. An activation element 35 which in the present exemplary embodiment is designed as a stud and which in the activation of the trigger lever 3 pushes the paint needle, or an element, for example an entrainment element or a stopper, that in the axial direction is fixedly connected to the paint needle, respectively, rearward and thus moves the paint needle out of the paint nozzle opening and thus exposes the paint nozzle opening to the material to be sprayed is located between the arms 34a, 34b. The present trigger lever 3 at the lower end has a sculpted region 38 which guarantees a secure grip on the trigger lever for the user of the spray gun. A receptacle installation 40a, 40b in the form of bores which in each case can have one conical region and completely penetrate the front face 31 is incorporated in the front face 31 of the trigger lever 3. This receptacle installation 40a, 40b serves for receiving fastening means 221, 222 of the trigger lock 2. In the present exemplary embodiment, the fastening means 221, 222 are disposed on a gliding rail 22a. A gliding element 22b is mounted so as to glide, that is to say displaceably, on this gliding rail 22a. The gliding element 22b has internal grooves 24 in which webs 26 on the gliding rail 22a engage. The gliding element 22b simultaneously has webs 28 which engage in grooves 29 in the gliding rail 22a. A detent 29a for the webs 28 of the gliding element 22b is located on each lower end of the grooves 29. Bearing faces 30 on the lower end of the webs 28 correspond to the shape of the detents 29a. In the present exemplary embodiment, the detents 29a and the bearing faces 30 that function as mating elements are designed so as to be oblique. A latching cam that is designed as a protrusion 280 which in each case engages in one groove 260 in the web 26 of the gliding rail 22a when the gliding element 22b has reached an upper position on the gliding rails 22a is disposed in the lower region of each of the grooves 24 in the gliding element 22b. By means of this fixing mechanism that is designed as a latching mechanism and is composed of grooves and latching cams it is possible for the position of the gliding element 22b to be fixed on the gliding rail 22a, in particular for the gliding element 22b to be held in an upper position. The trigger lock 2 is preferably moved to the blocking position in that the gliding element 22b is slid to this upper position. Since the force that is created by the activation of the trigger lever 3 and acts on the trigger lock 2 arises so as to be substantially perpendicular to the direction of movement of the gliding element 22b on the gliding rail 22a, the fixing mechanism does not have to be designed so as to fix in a particularly intense manner. The fixing mechanism has to fix the gliding element 22b substantially only in relation to gravity and to minor unintentional contact in the direction of movement of the gliding element 22b on the gliding rail 22a. The gliding element 22b on that outside that faces away from the grooves 24 and webs 28 has an activation region 240 which in the present exemplary embodiment is designed as a curved face, wherein the largest region of the face is substantially perpendicular to the direction of movement of the gliding element 22b on the gliding rail 22a. A simple activation of the trigger lock 2 by the user is possible on account thereof.

FIG. 4 shows a sectional view of the trigger lever 3 having a fitted trigger lock 2 from FIG. 3, sectioned along a plane through the bores 36a, 36b in the arms 34a, 34b of the trigger lever 3 and through the grooves 24 of the gliding element 22b of the trigger lock 2, with a view toward the inside of the trigger lever 3. It can be seen that the gliding rail 22a tapers toward the bottom, or widens toward the top, respectively, while the gliding element 22b across the entire profile thereof has the same width, except for the lower end of said gliding element 22b in the region of the latching cams that are designed as protrusions 280 and in FIG. 4 lie in the grooves 260 of the gliding rail 22a. The gliding element 22b is thus fixed in an upper position on the gliding rail 22a, preferably in the blocking position. The widening of the gliding rail 22a toward the top ensures further fixing of the gliding element 22b, presently in a friction-engaging manner. As is also shown in FIG. 3, some edges of the gliding rail 22a and of the gliding element 22b have chamfers which facilitate sliding the gliding element 22b onto the gliding rail 22a.

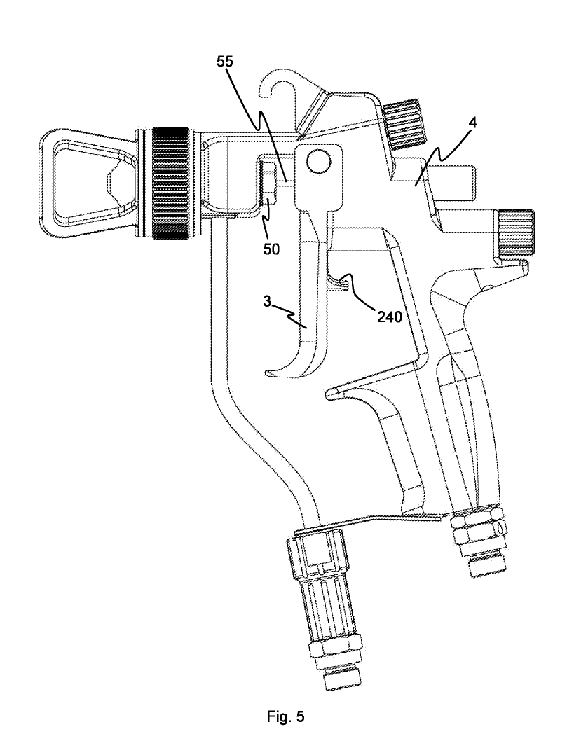

FIG. 5 shows the exemplary embodiment of a spray gun according to the invention from FIG. 1 and FIG. 2 in a side view. It can be seen that in particular the activation region 240 of the gliding element 22b protrudes rearward from the trigger lever 3. A fixing screw 50 which is disposed about the paint needle 55 and which fixes a needle seal in the gun body 4, for example, can likewise be seen.

Finally, it is to be pointed out that the exemplary embodiment described only describes a limited selection of potential exemplary embodiments and thus does not represent any limitation of the present invention.

What is claimed is:

1. A spray gun, in particular a paint spray gun, having at least a gun body, a trigger lever and a trigger lock for preventing activation of the trigger lever, wherein at least one part of the trigger lock is displaceable from an activation position, in which the activation of the trigger lever is possible, to a blocking position, in which the activation of the trigger lever is not possible, and is displaceable from the blocking position to the activation position, wherein the trigger lock has at least one slider element, wherein the slider element both in the activation position as well as in the blocking position is at least partially disposed in an intermediate space between the trigger lever and the gun body.

2. The spray gun of claim 1, wherein the slider element in the activation position is at least partially disposed in a first region of the intermediate space between the trigger lever and the gun body, and wherein the slider element in the blocking position is at least partially disposed in a second region of the intermediate space between the trigger lever and the gun body, and wherein at least one dimension of the slider element corresponds approximately to the spacing between the non-activated trigger lever and the gun body in the second region of the intermediate space between the trigger lever of the spray gun and the gun body of the spray gun.

3. The spray gun of claim 1, wherein the slider element of the trigger lock has at least a gliding rail and a gliding element.

4. The spray gun of claim 1, wherein the slider element of the trigger lock has a gliding element, and the gliding rail is part of the trigger lever of the spray gun.

5. The spray gun of claim 3, wherein the slider element has a fixing mechanism by means of which the position of the gliding element on the gliding rail is capable of being fixed.

6. The spray gun of claim 3, wherein the gliding element and the gliding rail are interconnected by a dovetail guide.

7. The spray gun of claim 1, wherein the slider element is disposed on the gun body of the spray gun.

8. The spray gun of claim 1, wherein the slider element is disposed on the trigger lever of the spray gun.

9. The spray gun of claim 1, wherein said spray gun furthermore has an air piston rod which is movable by activating the trigger lever, and wherein the slider element is designed in such a manner that the slider element is at least partially displaceable in an intermediate space between the trigger lever and a region of the gun body of the spray gun that surrounds the air piston rod.

10. The spray gun of claim 1, wherein the slider element for activating the blocking position of the trigger lock is at least partially displaceable from a first region of the intermediate space between the trigger lever and the gun body, having a comparatively large spacing between the trigger lever and the gun body, to a second region of the intermediate space between the trigger lever and the gun body, having a comparatively small spacing between the trigger lever and the gun body.

11. A trigger lock for a spray gun, in particular a paint spray gun, wherein said trigger lock has at least a slider element and a fastening means for disposing the trigger lock at least partially in an intermediate space between a trigger lever of the spray gun and a gun body of the spray gun.

12. The trigger lock of claim 11, wherein the trigger lock is disposed so as to be releasable on the spray gun.

13. The trigger lock of claim 11, wherein the slider element in an activation position is at least partially located in a first region of the intermediate space between the trigger lever of the spray gun and the gun body of the spray gun, and the slider element in a blocking position is at least partially located in a second region of the intermediate space between the trigger lever of the spray gun and the gun body of the spray gun, and wherein at least one dimension of the slider element corresponds approximately to the spacing between the non-activated trigger lever and the gun body in the second region of the intermediate space between the trigger lever of the spray gun and the gun body of the spray gun.

14. A method for activating a trigger lock of a spray gun, in particular a paint spray gun, wherein the activation comprises at least one sliding motion, and wherein a slider element both prior to as well as after the activation of the trigger lock is at least partially located in an intermediate space between a trigger lever of the spray gun and a gun body of the spray gun.

15. The method of 14, wherein the slider element is at least partially slid from a first region of the intermediate space between the trigger lever and the gun body, having a comparatively large spacing between the trigger lever and the gun body, to a second region of the intermediate space between the trigger lever and the gun body, having a comparatively small spacing between the trigger lever and the gun body.

16. A method for deactivating a trigger lock of a spray gun, in particular a paint spray gun, wherein the deactivation comprises at least one sliding motion, and wherein a slider element both prior to as well as after the deactivation of the trigger lock is at least partially located in an intermediate space between a trigger lever of the spray gun and a gun body of the spray gun.

17. The method of claim 16, wherein the slider element is at least partially slid from a second region of the intermediate space between the trigger lever and the gun body, having a comparatively small spacing between the trigger lever and the gun body, to a first region of the intermediate space between the trigger lever and the gun body, having a comparatively large spacing between the trigger lever and the gun body.
